(19) United States
(12) Patent Application Publication
(10) Pub. No.: US 2008/0125926 A1
(43) Pub. Date: May 29, 2008

(54) Electric Vehicle Control Device

(75) Inventors: Yasuaki Mamoto, Tokyo (JP); Hidetoshi Sumita, Tokyo (JP)

Correspondence Address: BUCHANAN, INGERSOLL & ROONEY PC, POST OFFICE BOX 1404, ALEXANDRIA, VA, 22313-1404, US

(73) Assignee: Mitsubishi Electric Corporation, Tokyo (JP)

(21) Appl. No.: 11/666,085

(22) PCT Filed: Oct. 27, 2005
(86) PCT No.: PCT/JP05/19788

§ 371 Date: Apr. 24, 2007

(30) Foreign Application Priority Data
Oct. 28, 2004 (JP) 2004-313865

(51) Int. Cl. B60K 6/40; B60K 6/405

(52) U.S. Cl. 701/22; 903/951; 903/952

(57) ABSTRACT

A plurality of electric devices constituting an electric vehicle control device (6) are arranged as a unitary block of a frame and a case. A fixed unit (6a) is arranged at several positions on a horizontal plane between the upper end and the lower end of the electric control device mounted on an electric vehicle (1). The electric devices are arranged so that the center of gravity of the electric vehicle control device (6) is substantially on the horizontal plane of the fixed unit (6a). Since it is possible to suppress vibration during travel of the electric vehicle, it is possible to reduce the strength of the electric vehicle and reduce its weight.

### TECHNICAL FIELD

The invention relates to an electric vehicle control device mounted in an electric vehicle, and more particularly to an electric vehicle control device that can suppress vibration that is generated when the electric vehicle is traveling.

### BACKGROUND ART

In conventional electric vehicle control devices, a plurality of electric devices are disposed in an open member located at an upper surface side of a case provided in a housing member on a roof of an electric vehicle, and a closed member that forms the inner side of the case. The electric devices and the case are integrated. Furthermore, fixing to a vehicle body is provided using a support frame that forms fixing members formed between the open member and the closed member (for an example, refer to Patent Document 1).

[Patent Document 1] JP-A-61-220961 (pages 2 and 3, FIG. 2)

### DISCLOSURE OF THE INVENTION

### Problems that the Invention is to Solve

The known electric vehicle control devices are fixed to the electric vehicle by the support frame formed by the fixing members provided between an upper end and a lower end of the electric vehicle control device. However, the center of gravity of the plurality of electric devices is not taken into consideration when determining the position of the fixing members, and thus there is a possibility that vibration will be generated when the electric vehicle is traveling. To address this, it is necessary to increase the strength of the electric vehicle that supports the electric vehicle control device, which results in an increase in the weight of the electric vehicle.

The invention has been devised in order to solve the above described problems, and it is an object thereof to provide an electric vehicle control device that can suppress vibration that is generated during traveling of an electric vehicle.

### Means for Solving the Problems

An electric vehicle control device according to the invention is attached to an electric vehicle in which a plurality of electric devices that configure the electric vehicle control device are integrated with and disposed on a frame body, a case body or the like, and fixing members are provided at a plurality of positions on a horizontal plane between an upper end and a lower end of the electric vehicle control device. The plurality of the electric devices is arranged such that the center of gravity of the electric vehicle control device is substantially positioned on the horizontal plane of the fixing members.

### ADVANTAGE OF THE INVENTION

Because the plurality of electric devices are arranged and integrated such that the center of gravity is substantially positioned on the horizontal plane of the fixing members, the electric vehicle control device of the invention is able to suppress vibration the occurs when the electric vehicle is traveling. As a result, the strength of the electric vehicle can be reduced and weight reduction can be promoted.

### BEST MODE FOR CARRYING OUT THE INVENTION

### First Embodiment

FIG. 1 is a side view showing an electric vehicle of a first embodiment, FIG. 2 is a cross sectional view along line II-II of FIG. 1, and FIG. 3 is a cross sectional view along line III-III of FIG. 2.

In FIG. 1 to FIG. 3, coupled electric vehicles 1, 2 form a train. The electric vehicle 1 receives direct current power from an overhead power line 4 via a pantograph 3. An electric vehicle control device 6 is disposed on a roof 5, and controls an electric vehicle drive motor (not shown).

The electric vehicle control device 6 is housed in a housing member 5a that is formed by making a recess in the roof of electric vehicle 1. In addition, a cover 7 is positioned so as to cover the electric vehicle control device 6.

The electric vehicle control device 6 disposed in the above described manner is configured by a plurality of electric devices such as semi-conductors, coils, various types of switches, and the like (none of which are shown in the figure). And the plurality of electric devices that configure the electric vehicle control device 6 are positioned on a frame body, a case body or the like, and integrated therewith.

Furthermore, fixing members 6a are provided at a plurality of positions between the upper end and the lower end of the electric vehicle control device 6. The electric vehicle control device 6 is attached to the electric vehicle 1 by fixing means (not shown) like a bolt or nut using the fixing members 6a. The electric vehicle control device 6 is formed with an upper housing member 6b at the upper edge side of the fixing members 6a, and a lower housing member 6c at the lower edge side of the fixing members 6a. Moreover, the plurality of electric devices that configure the electric vehicle control device 6 are positioned in the upper housing member 6b and the lower housing member 6c while taking into consideration factors like the wiring sequence. Note that, each electric device is positioned in each housing member 6b, 6c such that the center of gravity of the electric vehicle control device 6 is substantially on the horizontal plane of the fixing members 6a.

As described above, the plurality of electric devices are positioned and integrated such that the center of gravity is substantially positioned on the horizontal plane of the fixing members. As a result, the electric vehicle control device of a first embodiment of the invention is able to suppress the occurrence of vibration when the vehicle is traveling, whereby the strength of the electric vehicle can be reduced and weight reduction can be promoted.

Note that, in the first embodiment, an example is described in which the electric vehicle control device 6 is disposed in the housing member on the roof of the electric vehicle 1. However, the invention is not limited to this, and a structure in which the electric vehicle control device is disposed under the floor of the electric vehicle can be expected to achieve the same effects.

### BRIEF DESCRIPTION OF THE DRAWINGS

FIG. 1 is a side view showing an electric vehicle of a first embodiment of the invention.

FIG. 2 is a cross sectional view along line II-II of FIG. 1

FIG. 3 is a cross sectional view along line III-III of FIG. 2.

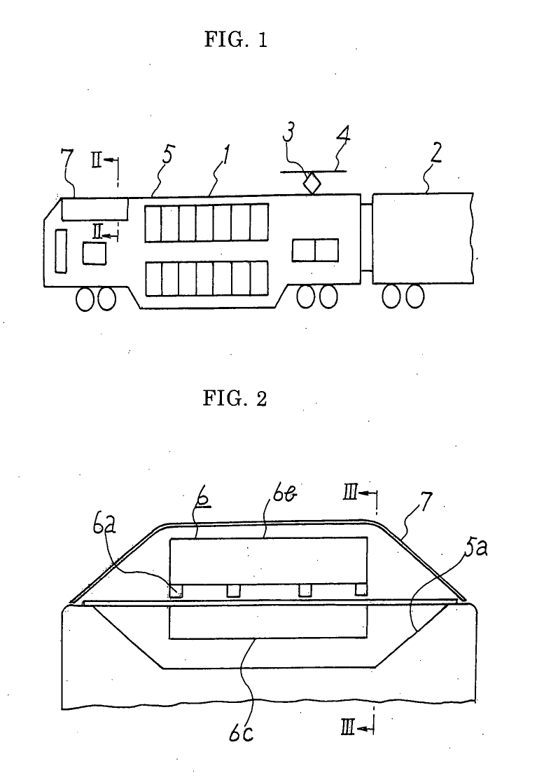

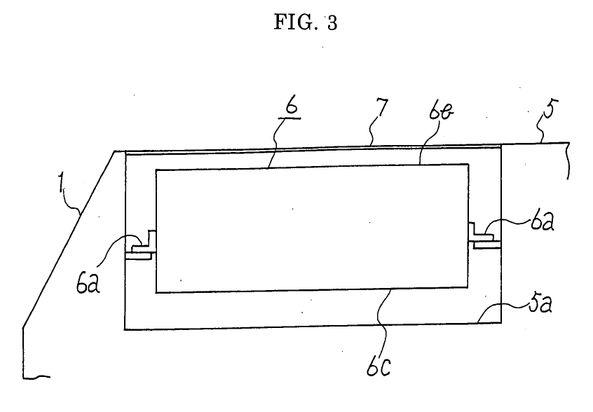

### DESCRIPTION OF THE REFERENCE NUMERALS AND SIGNS

Electric vehicle, 5a Housing member, 6 Electric vehicle control device, 6a Fixing member, 6b Upper housing member, 6c Lower housing member

1. An electric vehicle control device attached to an electric vehicle in which a plurality of electric devices that configure the electric vehicle control device are integrated with and disposed on a frame body, a case body or the like, and fixing members are provided at a plurality of locations on a horizontal plane between an upper end and a lower end of the electric vehicle control device, wherein the plurality of electric devices are arranged such that the center of gravity of the electric vehicle control device is substantially positioned on the horizontal plane of the fixing members.

2. The electric vehicle control device according to claim 1, wherein an upper housing member is formed at an upper edge side of the electric vehicle control device that is above the fixing members, and a lower housing member is formed at a lower edge side that is below the fixing members, wherein each of the electric devices is disposed in the upper housing member and the lower housing member.

3. The electric vehicle control device according to claim 1 wherein the electric vehicle control device is disposed in a housing member formed on a roof of the electric vehicle.

4. The electric vehicle control device according to claim 2 wherein the electric vehicle control device is disposed in a housing member formed on a roof of the electric vehicle.
